(19) United States
(12) Patent Application Publication
(10) Pub. No.: US 2010/0312861 A1
(43) Pub. Date: Dec. 9, 2010

(54) METHOD, NETWORK, AND NODE FOR DISTRIBUTING ELECTRONIC CONTENT IN A CONTENT DISTRIBUTION NETWORK

(76) Inventors: Johan Kolhi, Vaxholm (SE); Ayodele Damola, Solna (SE); Victor Souza, Stockholm (SE)

Correspondence Address: ERICSSON INC., 6300 LEGACY DRIVE, M/S EVR 1-C-11, PLANO, TX, 75024, US

(21) Appl. No.: 12/745,197

(22) PCT Filed: Nov. 18, 2008
(86) PCT No.: PCT/IB2008/003125

§ 371 Date: May 27, 2010

Related U.S. Application Data
(60) Provisional application No. 60/991,319, filed on Nov. 30, 2007.

(51) Int. Cl. G06F 15/16

(52) U.S. Cl. 709/219

(57) ABSTRACT

A method, network, and node for distributing content across a plurality of content cache nodes to provide optimal access to the content. Relevant, e.g. popular, content is distributed as close as possible to the user or group of users that have the highest probability of requesting the content. In addition, content is relocated to caching nodes higher in the aggregation network as content become less demanded, e.g. less popular. Portions of the content are distributed in a plurality of content cache nodes, and locations where particular portions of the content are requested by users with greater frequency than other locations are determined. The content portions are then migrated to content cache nodes closer to the locations where the particular portions of the content are requested by users with greater frequency.

### TECHNICAL FIELD

The present invention relates generally to communications networks, and in particular, to a method, network, and node for efficiently distributing electronic content in a content distribution network.

### BACKGROUND

Content delivery networks (CDNs) provide a caching infrastructure in IP networks to support multimedia services. Existing methods and systems used in CDNs do not take into account the different possible factors that affect optimal content placement in cache nodes. As a result, content distribution makes inefficient use of network resources.

### SUMMARY

It would be advantageous to have a method, network, and node where content is located where it is most likely to be requested. It is difficult, however, to implement such a solution when running on the open Internet. A first problem is that locality information cannot be simply inferred from the requests. A second problem is that a truly optimal location of content can only be obtained with a thorough understanding of the network topology, which is not readily discernable in the open Internet architecture where Internet Service Providers or Network Service Providers attempt to hide their internal topologies.

Therefore, there is a need for a method, network, and node for positioning content for use in a CDN in an optimal location. Specifically, it would be advantageous to have a method, network, and node where content is distributed across a plurality of content cache nodes in a CDN.

The present invention is directed to a method, network, and node for distributing electronic content across a plurality of content cache nodes to provide optimal access to the content. The present invention positions relevant (e.g., popular) content as close as possible to the user or group of users that have the highest probability of requesting the content. In addition, the present invention relocates content to caching nodes higher in the aggregation network as content become less demanded (e.g., less popular).

Thus, in one embodiment, the present invention is directed to a method of dynamically distributing electronic content in a content delivery network. The method begins by distributing portions of the content in a plurality of content cache nodes. Next, locations where particular portions of the content are requested by users with greater frequency than other locations are determined. The particular portions of the content to content cache nodes are migrated closer to the locations where the particular portions of the content are requested by users with greater frequency.

In another embodiment, the present invention is directed to a content delivery network having a plurality of content cache nodes to which portions of the content are distributed. The network determines locations where particular portions of the content are requested by users with greater frequency than other locations, and migrates those particular portions of the content to content cache nodes closer to the locations where the particular portions of the content are requested by users with greater frequency.

In still another embodiment, the present invention is directed to a node for storing content in a content delivery network having a plurality of content cache nodes to which content is distributed. The node stores content for use in the content delivery network, determines locations where particular portions of the content are requested by users with greater frequency than other locations, and determines if the particular portions of the content are stored in the node or migrated to other nodes for optimal distribution of the particular portions of the content. The node then migrates the particular portions of the content to content cache nodes more optimally positioned for delivery of the particular portions of the content.

### BRIEF DESCRIPTION OF THE DRAWINGS

FIG. 1 is a simplified block diagram of a hierarchical caching system deployed in a Content Delivery Network (CDN) in an exemplary embodiment of the present invention;

FIG. 2 is a simplified block diagram of an exemplary access network with a hierarchy of cache nodes in a broadband access network based CDN;

FIG. 3 is a simplified block diagram illustrating an exemplary cache hierarchy in the Internet;

FIG. 4 is a simplified block diagram of an exemplary network topology and media routing table in an exemplary embodiment of the present invention;

FIG. 5 is a simplified block diagram illustrating content migration in an exemplary embodiment of the present invention; and

FIG. 6 is a flowchart illustrating the steps of dynamically distributing content in a CDN according to the teachings of the present invention.

### DETAILED DESCRIPTION

The present invention is a system and method of controlling content distribution networks to provide content in optimal locations in the network.

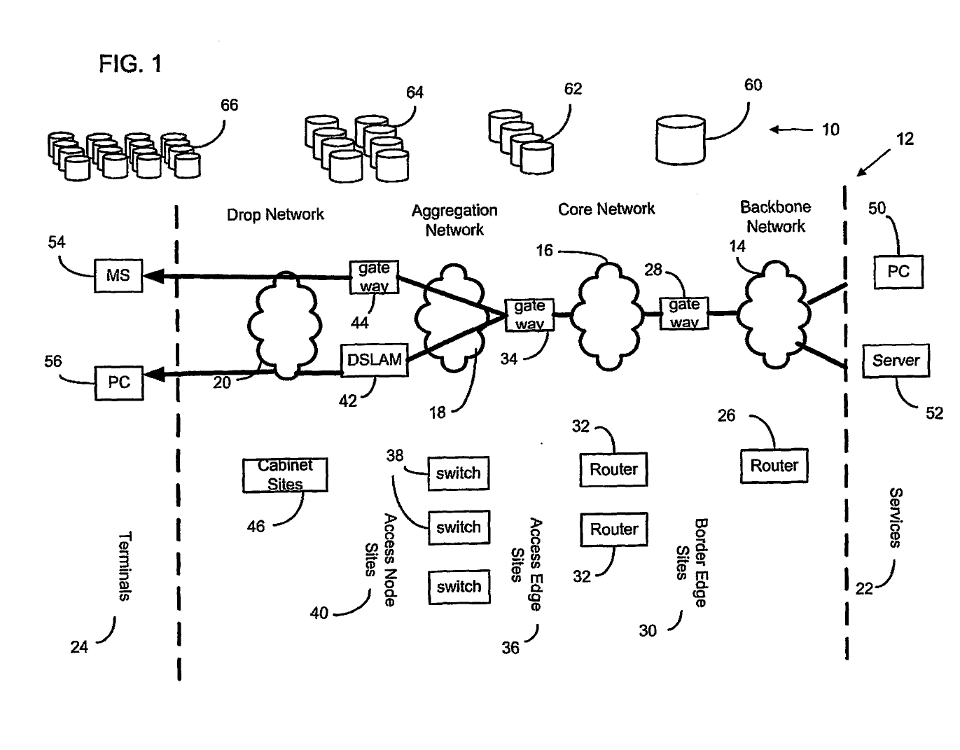

FIG. 1 is a simplified block diagram of a hierarchical caching system 10 deployed in a Content Delivery Network (CDN) 12 in an exemplary embodiment of the present invention. The CDN depicted in FIG. 1 includes a backbone network 14, a core network 16, an aggregation network 18, a drop network 20 providing communications between services 22 and terminals 24. The backbone network 14 includes a plurality of backbone routers 26. Between the backbone network and the core network 16 is a border gateway 28 which includes border edge sites 30. The core network 16 includes a plurality of core routers 32. Between the core network 16 and the aggregation network 18 is an access edge gateway 34 and access edge sites 36. The aggregation network 18 includes a plurality of aggregation switches 38. Between the aggregation network and the drop network is access node sites 40, such as a Digital Subscriber Line Access Multiplexer (DSLAM) 42 and a gateway 44. The drop network 20 may include cabinet sites 46. The services may include a wide variety of nodes, such as a personal computer 50, a server 52, etc. The terminals 24 may include mobile stations 54, personal computer 56, etc.

The present invention utilizes a plurality of hierarchical caches to store content. The top portion of FIG. 1 illustrates a plurality of cache nodes at different levels of the CDN 12. As depicted in FIG. 1, the plurality of cache nodes includes a first (root) level 60 of caches located nearest the services. Next, between the core network 16 and the aggregation network 18 is a second level 62 of cache nodes. Between the aggregation network and the drop network 16 is a third level 64 of cache nodes. At the terminal level is located a fourth level 66 of cache nodes. Although FIG. 1 depicts a fully distributed system, the present invention may also be applied to model network-only equipment. In addition, although several different types of networks and nodes are shown, it should be understood that the present invention may be implemented with any number and type of nodes and networks.

In the present invention, if a given media content is not found locally, the system 10 seeks content in the next level of caching (recursively). The present invention provides optimal placing and managing of content in CDNs.

The placement of caching in a given location strongly affects the overall performance of the system. If clients are not able to find the content in the cache nodes, the system is ineffective and the client will have to retrieve the content from the original source. When a client is not able to find content in a given cache node, this is called a cache-miss, which is undesirable.

Content is distributed across the content cache nodes (i.e., first level 60, second level 62, third level 64 and fourth level 66) to provide optimal access to the content by the terminals. The ultimate goal is to place relevant (popular) content as close as possible to the user or group of users that have a high probability of requesting it. Additionally, content which becomes less demanded (i.e., less popular), is relocated to caching nodes higher in the aggregation network. The network may be either an access network or the Internet.

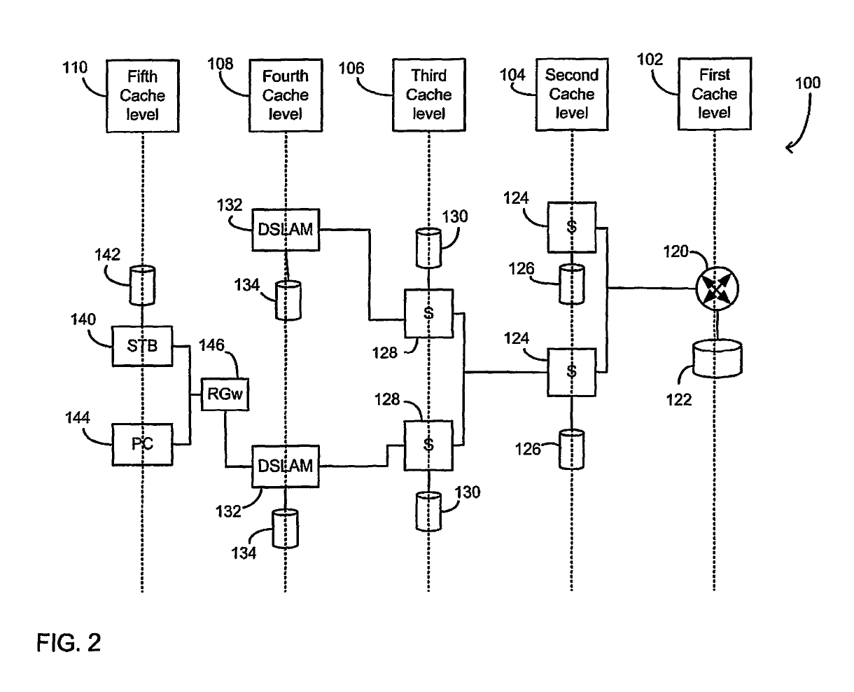

FIG. 2 is a simplified block diagram of an exemplary access network 100 with a hierarchy of cache nodes in a broadband access network-based CDN. In an access network, the operator is aware of the physical topology of the network and the location of cache nodes. A star or ring shaped topology may be used in this embodiment, which would influence the content distributing algorithm utilized in the caching system. The access network 100 includes a first level 102 of cache nodes, a second level 104 of cache nodes, a third level 106 of cache nodes, a fourth level 108 of cache nodes, and a fifth level 110 of cache nodes. The cache levels show the closeness or proximity between the end user and the content. Thus, the present invention strives to enhance the proximity of the content in a dynamic environment of a typical network. Links between cache nodes are defined by capacity, bandwidth constrains, jitter, delay, and average packet loss rate. As depicted in FIG. 2, at the first level 102 of cache nodes are associated a gateway 120 and a root cache 122. At the second level 104 of cache nodes are Server (S) nodes 124 and corresponding caches 126. At the third level 106 are S nodes 128 and corresponding caches 130. At the fourth level are DSLAMs 132 and corresponding caches 134. The fifth level 110 of cache nodes may include a Set Top Box (STB) 140 with a cache 142 and a Personal Computer (PC) 144 connected to one of the DSLAMs 132 by an RGw 146.

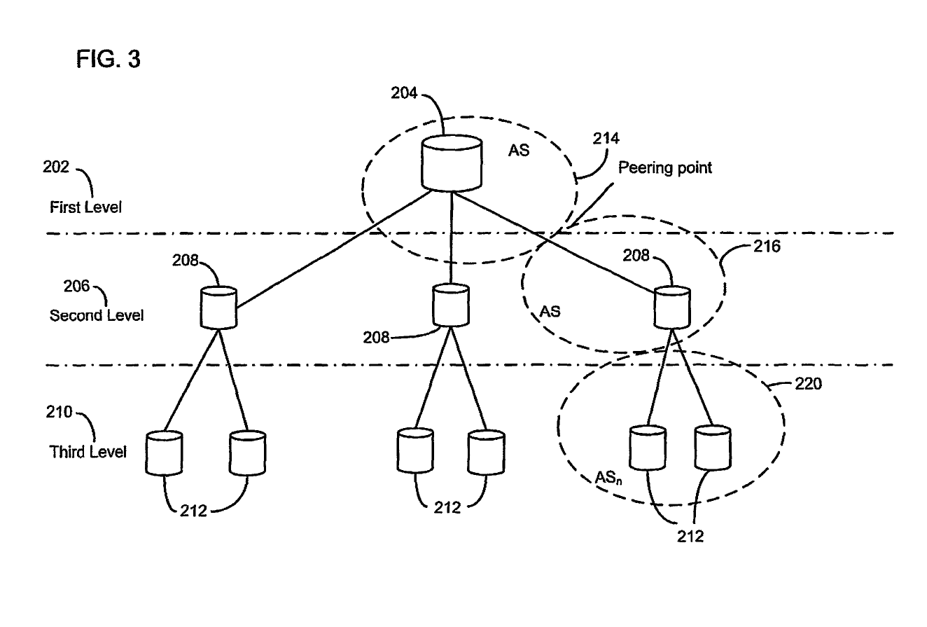

FIG. 3 is a simplified block diagram illustrating an exemplary cache hierarchy in the Internet 200. As depicted, there is a first level 202 of cache nodes having a root cache node 204, a second level 206 of cache nodes having cache nodes 208, and a third level of cache nodes 210 having cache nodes 212. The root cache node is located in an Autonomous System (AS) 214. One of the cache nodes 208 is located in an AS 216. As depicted in FIG. 3, two of the cache nodes 212 are located in an ASₙ 220. In the Internet, the exact underlying network topology is not easily discoverable. Thus, parameters such as network domains and autonomous systems defining geographical or business boundaries are of particular importance. Links between caches are defined in terms of Service Level Agreements (SLAs).

FIG. 3 illustrates a CDN covering several operators/autonomous systems in the Internet 200. The CDN may cross several peering points. Traffic exchange over the peering points is preferably avoided if possible. Smart caching provided by the present invention may reduce unnecessary transit traffic.

In the present invention, there are four main factors to determine the way content is distributed between levels: abstract factor; physical factor; content demand factor; and business factor. Abstract factor determines how far from the user is the content. As the name implies, this is an abstract concept. It is used to make a decision if content should be moved closer to the user or moved away from the user towards the head-end with the long-tail (or backend) server. The abstract factor is the cache level.

The physical factor provides a determination of the neighbors of a given cache node in a given cache level. This information helps define the closest set of caches nodes where content may be fetched. The physical factor is dependent on the physical topology of the network and also on the conditions of the links which connect the various cache nodes. In addition, the physical factor defines a set of neighbors of a cache node. This is a list of nodes arranged in order of preference as to where the content is best accessed. Network link characteristics influence the order of this list. In an access network, information on available bandwidth in links is used to determine the list order. The list order is dynamically configured to react to the dynamic network environment. In the internet model, the transit cost SLA is preferably used. In this embodiment, the list is more static.

In the Internet scenario, two basic approaches may be taken to gather more information about the physical network: active and passive probing. Active probing occurs when the cache nodes send packets to each other and monitor certain parameters such as bandwidth, jitter, delay, number of hops and average packet lost. Passive probing takes advantage of the packets that are being sent between the cache nodes and extracts information from packets. Regardless of the method used to obtain the physical information in the Internet, this data is used together with the transit SLAs to decide the optimal location to position the content. In addition, manual configuration is also a way of specifying neighbors.

Content demand factor is based on observed and expected information. Observed information is derived from a measure of popularity of content based on a real-time measurement of the demand of the content. As more user requests are made for a particular content, the content is moved or replicated between levels. Expected information is used to predict which cache nodes to populate with which content before the content has actually been requested by the user. Expected information may be sourced from the knowledge that a particular asset will be in high demand, for example the release of a Hollywood blockbuster. The history of user viewing habits may also be used to create this information. Content that is expected to be requested is pre-cached at strategic cache nodes close to the potential users that may request the content.

Business factor is a caching decision which is based on payments from a content or service provider. The content/service providers' interest is to provide cached content to be located closer to the viewer. This more localized caching decreases delay and jitter, thereby improving the viewer experience. In particular, HD-content distribution (streaming or downloading) is affected by the content location. For streaming content, the issue is degraded viewing experience based on packet loss. For downloading, it is the time between content request and the state of the system ready for playout which is affected.

The present invention utilizes these factors to define the information needed to make a decision on the distribution and location of content in the network. In one embodiment of the invention the abstract, physical, content demand, and business factors are mapped to a tuple. The tuple defines the proximity of the content relative to the user, the closest cache nodes to the node where the content currently resides, and the popularity of the content:

[level, neighbor-list, popularity, payment (minimum caching level, expiration time/date)]

In an access network, the neighbor nodes may change often as the available bandwidth changes. A neighbor list is maintained in each caching node. The first node (e.g., default-neighbor node) in the neighbor list is the most preferred node to fetch content from for a given node.

The payment field in the tuple tells the caching network what minimum level of caching was agreed for a piece of content. The payment field also has an expiration time/date that tells the CDN when this agreement ends.

In the present invention, an actual implementation of a cache node may either reside externally or internally with the network node element. For example, an Internet Protocol (IP) DSLAM with an embedded cache node may be utilized. In another embodiment, a network site consisting of a number of DSLAMs sharing one or several external caching nodes may be used. A cache node may comprise one or more caching systems connected to one of a plurality of storage systems. In one embodiment, the caching system is the computing/processing element and the storage system is the disks or disk arrays.

During configuration of the CDN, a hierarchy of nodes is created and assigned numbers at the various levels. The neighbor list is either created manually, as part of the network configuration process, or auto-discovered during CDN runtime.

In the preferred embodiment of the present invention, all content is first stored in the head-end cache node. In an alternate embodiment of the present invention, the content is initially randomly replicated across a set of cache nodes. As users begin to request content assets, information on the interest of the content is recorded. A downward replication of the content is started for popular content. Candidate nodes that form the neighbor-list are created from the nodes of the same cache level and from the cache level immediately higher than the node in question. Dynamic network conditions affect the ordering in this list. Thus, if the available bandwidth is lower than a specific threshold, then the default-neighbor is appointed as another node from the neighbor-list.

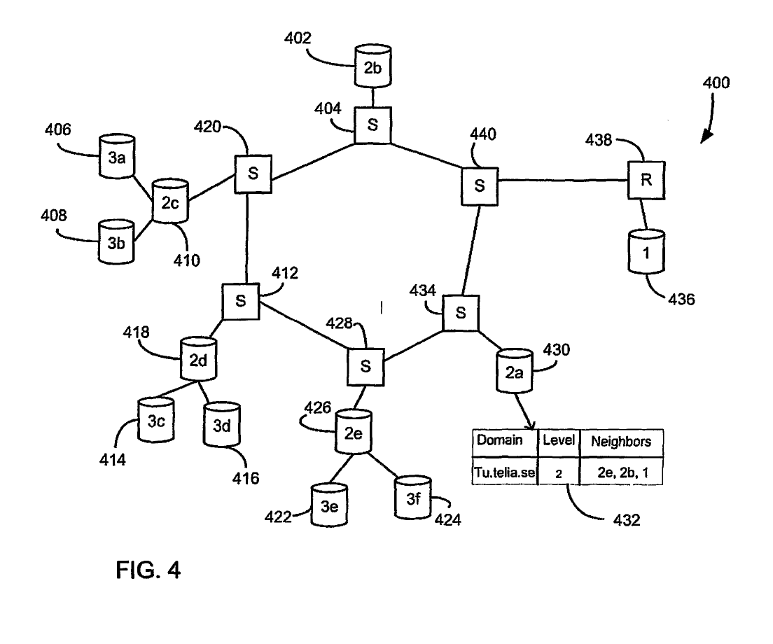

FIG. 4 is a simplified block diagram of an exemplary network topology and media routing table in one embodiment of the present invention. FIG. 4 illustrates a caching system 400 having cache nodes 402 associated with a Switch (S node) 404, cache nodes 406, 408, and 410 associated with an S node 420, cache nodes 414, 416, and 418 associated with an S node 412, cache nodes 422, 424, 426 associated with an S node 428, a cache node 430 having table 432 and associated with an S node 434, a cache node 436 associated with a Router (R node) 438, and an S node 440. The numbers inside each cache node represents the cache level.

Commands may be issued from content management systems to replicate, move or erase content in the various cache levels. When insertion of contents occurs, it can be injected at a certain level directly in the CDN. For example, if a new movie is expected to become very popular, it may preferably be injected at a level relatively far out in the CDN (i.e., closer to the end-users). This may be part of a business agreement where a movie production studio desires to provide content at higher levels.

For long tail media, (i.e., media that is rarely accessed), initial injection is preferably at the central level only. Replication to lower levels may take place if popularity passes a specified threshold in the CDN. This is to ensure that only a specified popularity metrics threshold is attained prior to replicating or moving between cache levels.

In addition, content may have different popularity levels in different geographical locations. For example, an Italian cooking program may be very popular in an area with many Italian immigrants, while the same program is unpopular in another region of the country. Thus, the present invention adapts different viewing patterns in different areas, thereby caching content as needed for the dynamic situation.

In the present invention, multi-level caching of content may provide redundancy. For example, if a cache at a lower level breaks or is overloaded with requests, a higher level cache is capable of sharing the load.

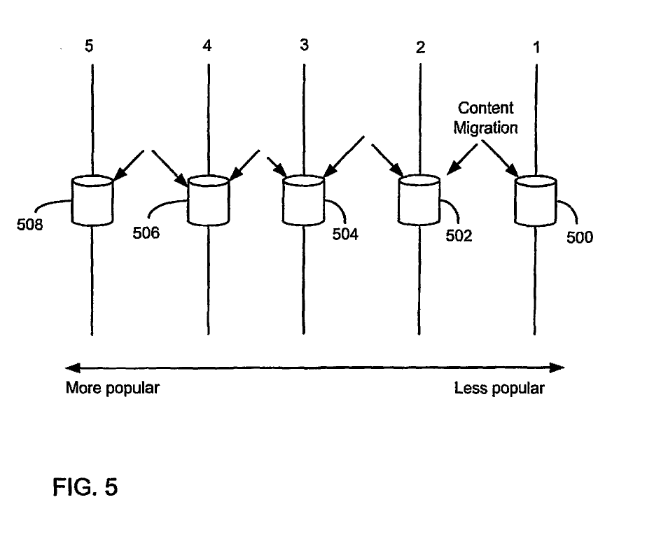

FIG. 5 is a simplified block diagram illustrating content migration in an exemplary embodiment of the present invention. In this embodiment, as content popularity changes, the content is moved or replicated between the different cache levels. A cache node 500 is located at a first cache level, a cache node 502 is located at a second cache level, a cache node 504 is located at a third cache level, a cache node 506 is located at a fourth cache level and a cache node 508 is located a fifth cache level.

In the present invention, there are two main types of migration, replication and moving content. Replication is a pure copy operation. Content is left at the original level and copied to the next level. This next level could either be a higher or lower level, depending on the scenario. Moving is a copy and erase operation. Content is copied to the next level and erased from the original level. This level could either be a higher or lower level, depending on the scenario. Migration between levels may either be level wide or partial level, e.g., from level 1 to all level 2 caches, or from level 1 to level 2A-C.

There are several content migration strategies which may be employed. Content in a cache is retained based on its need (popularity) and not based on time (expiration date). Content in a cache may be rated with two parameters, hits and time stamp of last access. “Hits” is the total number of requests made for the content. Timestamp of last access is the last time the content was accessed. These parameters are local for each cache node. Thus, when a replication or move operation is conducted on the content, the hits and timestamp parameters are reset on both source and destination caches. This mechanism allows for aging of content to occur in the source cache. Aging is a concept which allows for optimum usage of the physical storage in a cache node. Every piece of content has an age weight based on the parameters above, which indicates the best candidate for removal from the cache node when new content arrives. By using age weight, the cache storage stores only the relevant content.

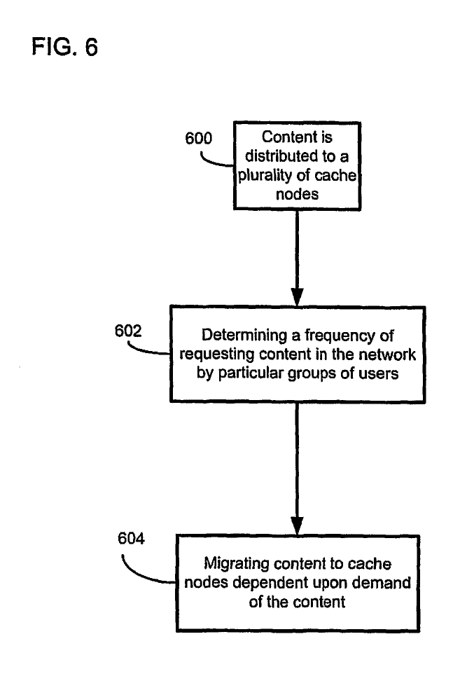

FIG. 6 is a flowchart illustrating the steps of dynamically distributing content in a CDN according to the teachings of the present invention. With reference to FIGS. 1-6, the method will now be explained. The method begins in step 600 where content is distributed in a plurality of content cache nodes. Next, in step 602, it is determined which content is requested by a group of particular users with greater frequency and which content is requested at a level of less frequency. In step 604, content is migrated to content cache nodes according to the demand of the content. For that content which is determined to be requested with greater frequency, the content is migrated to a cache level closer to the group of particular users requesting the content with great frequency. Likewise, for content which is determined to be requested with less frequency, the content is migrated to a cache level at a higher level in the aggregation network.

The present invention provides many advantages over existing systems. For the end-users, there are lower startup time (i.e., the time between the moment the end-user requests a given asset and the time the end-user starts viewing it). For the network operators, there also several advantages include reduction of unnecessary transit/peering costs, enhanced use of bandwidth resources by introducing an optimization algorithm for the CDN, creating new business opportunities in the form of caching services to be offered to content providers, and reduced network load as popular content traverses less nodes in the network. For content providers, the present invention provides the advantages of utilizing cache nodes that can be addressed as a group or individually (thereby making the caching far more flexible where level wide and partial level content caching is possible), flexible caching which provides lower costs, and the utilization of localized targeted content to specific communities.

The present invention may of course, be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1. A method of dynamically distributing electronic content in a content delivery network, the method comprising the steps of:
distributing portions of the content in a plurality of content cache nodes;
determining locations where particular portions of the content are requested by users with greater frequency than other locations; and
migrating the particular portions of the content to content cache nodes closer to the locations where the particular portions of the content are requested by users with greater frequency, said migrating step also including migrating a content or service provider's content to a location closer to an identified user when the provider has paid to have the provider's content stored in the location closer to the identified user.

2. The method according to claim 1, wherein the plurality of content cache nodes are arranged in either a logical or physical, hierarchical configuration having a local level with cache nodes located close to the users and at least one aggregation level with cache nodes serving larger areas or a greater number of users, wherein the step of migrating includes migrating frequently requested content to a cache node at the local level close to the users requesting the content, and migrating less frequently requested content to a cache node at the aggregation level.

3. The method according to claim 1 further comprising the steps of:
determining other portions of the content which are requested by users below a specified frequency threshold; and
upon determining the other portions of the content below the specified frequency threshold, migrating the other portions of the content to a content cache node in an aggregation level serving a larger area or a greater number of users.

4. The method according to claim 1 wherein the step of migrating includes replicating the particular portions in content cache nodes closer to the locations where the particular portions of the content are requested by users with greater frequency.

5. The method according to claim 1 wherein the step of migrating includes moving the particular portions in content cache nodes closer to the locations where the particular portions of the content are requested by users with greater frequency.

6. The method according to claim 1 further comprising the step of determining information regarding a physical configuration of the network by actively probing the plurality of cache nodes to determine parameters related to the physical configuration of the network.

7. The method according to claim 1 further comprising the step of determining information regarding a physical configuration of the network by passively probing packets sent between the cache nodes to determine parameters related to the physical configuration of the network.

8. The method according to claim 1 wherein each cache node is located in an internal network node in the network.

9. The method according to claim 1 wherein the step of determining locations includes the step of creating a neighbor list of candidate cache nodes to migrate the particular portions of content.

10. The method according to claim 1 wherein the step of determining locations includes the step of rating content based on a number of requests for the particular portions of content.

11. The method according to claim 1 wherein the step of determining locations includes the step of rating content based on a timestamp of last access to the particular portions of content.

12. A content delivery network having a plurality of content cache nodes to which portions of the content are distributed, the network comprising:
means for determining locations where particular portions of the content are requested by users with greater frequency than other locations; and
means for migrating the more frequently requested portions of the content to content cache nodes more optimally positioned for delivery of the more frequently requested portions of the content, and for migrating a particular provider's content to a location closer to an identified user in response to the provider paying to have the provider's content stored in the location closer to the identified user.

13. The content delivery network according to claim 12, wherein the plurality of content cache nodes are arranged in either a logical or physical, hierarchical configuration having a local level with cache nodes located close to the users and at least one aggregation level with cache nodes serving larger areas and/or a greater number of users, wherein the migrating means includes means for migrating frequently requested content to a cache node at the local level close to the users requesting the content, and for migrating less frequently requested content to a cache node at the aggregation level.

14. The content delivery network according to claim 12, further comprising:
means for determining other portions of the content which are requested by users below a specified frequency threshold; and
means for migrating the other portions of the content that fall below the specified frequency threshold to a content cache node in an aggregation level serving a larger area or a greater number of users.

15. The content delivery network according to claim 12, wherein the means for migrating includes means for replicating the particular portions in content cache nodes closer to the locations where the particular portions of the content are requested by users with greater frequency.

16. The content delivery network according to claim 12, wherein the means for migrating includes means for moving the particular portions in content cache nodes closer to the locations where the particular portions of the content are requested by users with greater frequency.

17. The content delivery network according to claim 12, further comprising means for determining information regarding a physical configuration of the network by actively probing the plurality of cache nodes to determine parameters related to the physical configuration of the network.

18. The content delivery network according to claim 12, further comprising means for determining information regarding a physical configuration of the network by passively probing packets sent between the cache nodes to determine parameters related to the physical configuration of the network.

19. The content delivery network according to claim 12, wherein each cache node is located in an internal network node in the network.

20. The content delivery network according to claim 12, wherein the means for determining locations includes means for creating a neighbor list of candidate cache nodes to migrate the particular portions of content.

21. The content delivery network according to claim 12, wherein the means for determining locations includes means for rating content based on a number of requests for the particular portions of content.

22. The content delivery network according to claim 12, wherein the means for determining locations includes means for rating content based on a timestamp of last access to the particular portions of content.

23. A node for storing content in a content delivery network having a plurality of content cache nodes to which content is distributed, the node comprising:
means for storing content for use in the content delivery network;
means for determining locations where particular portions of the content are requested by users with greater frequency than other locations;
means for determining if the particular portions of the content are stored in the node or migrated to other nodes for optimal distribution of the particular portions of the content; and
means for migrating the more frequently requested portions of the content to content cache nodes more optimally positioned for delivery of the more frequently requested portions of the content, and for migrating a particular provider's content to a location closer to an identified user in response to the provider paying to have the provider's content stored in the location closer to the identified user.

24. The node according to claim 23, wherein the means for determining locations includes means for creating a neighbor list of candidate cache nodes to migrate the particular portions of content.

25. The node according to claim 23, wherein the means for determining locations includes means for rating content based on a number of requests for the particular portions of content.

26. The network according to claim 23, wherein the means for determining locations includes means for rating content based on a timestamp of last access to the particular portions of content.
